(19) United States
(12) Patent Application Publication
(10) Pub. No.: US 2014/0045013 A1
(43) Pub. Date: Feb. 13, 2014

(54) NON-AQUEOUS ELECTROLYTE SECONDARY BATTERY

(71) Applicant: Sanyo Electric Co., Ltd., Moriguchi City (JP)

(72) Inventors: Keisuke Minami, Kanzaki-gun (JP); Toyoki Fujihara, Kanzaki-gun (JP); Toshiyuki Nohma, Kobe City (JP)

(21) Appl. No.: 13/943,113

(22) Filed: Jul. 16, 2013

(30) Foreign Application Priority Data
Aug. 9, 2012 (JP) 2012-177191

(51) Int. Cl. H01M 10/0561

(52) U.S. Cl. CPC H01M 10/0561
USPC 429/94

(57) ABSTRACT

To provide a non-aqueous electrolyte secondary battery having high capacity and superior safety.

The present invention is a non-aqueous electrolyte secondary including having a wound electrode assembly of a positive electrode, negative electrode and separator housed in an outer can having both a bottom and an opening, the opening being sealed by a sealing plate. This non-aqueous electrolyte secondary battery is characterized in that the battery further comprises a current interrupt device activated by rising pressure inside the battery, the bottom surface of the outer can is parallel to the direction of the winding axis of the wound electrode assembly, the thickness of the negative electrode at a state of charge of 100% is equal to or less than 130% of the thickness of the negative electrode at the time of battery assembly, the maximum width of the wound electrode assembly perpendicular to the winding axis direction during assembly is from 90 to 98% of the distance from the bottom surface of the outer can to the current interrupt device, and the battery capacity of the non-aqueous electrolyte secondary battery is equal to or greater than 4 Ah.

### CROSS-REFERENCE TO RELATED APPLICATIONS

This application claims the benefit of Japanese Patent Application No. 2012-177191 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the cycle characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrode have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current.

As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

Patent Document 1 Published Unexamined Patent Application No. 2010-086780

The technology disclosed in Patent Document 1 is a rectangular secondary battery having a first electrode core and a second electrode core on both ends in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved output characteristics as well as improved durability, such as storage characteristics and cycle characteristics. However, these points are not considered in Patent Document 1.

In view of this situation, an object of the present invention is to provide with high productivity a non-aqueous electrolyte secondary battery having superior safety.

### Means of Solving the Problem

In order to solve this problem, the present invention is a non-aqueous electrolyte secondary battery including having a wound electrode assembly of a positive electrode, negative electrode and separator housed in an outer can having both a bottom and an opening, the opening being sealed by a sealing plate. This non-aqueous electrolyte secondary battery is characterized in that the battery further comprises a current interrupt device activated by rising pressure inside the battery, the bottom surface of the outer can is parallel to the direction of the winding axis of the wound electrode assembly, the thickness of the negative electrode at a state of charge of 100% is equal to or less than 130% of the thickness of the negative electrode at the time of battery assembly, the maximum width of the wound electrode assembly perpendicular to the winding axis direction during assembly is from 90 to 98% of the distance from the bottom surface of the outer can to the current interrupt device, and the battery capacity of the non-aqueous electrolyte secondary battery is equal to or greater than 4 Ah.

In a wound electrode assembly, the opposing area of the positive and negative electrodes is advantageously large, and the assembly is easier to manufacture. In a high-capacity electrode having a battery capacity equal to or greater than 4 Ah, the collector structure can be simplified when the wound electrode assembly is housed so that its winding axis direction is parallel to the bottom surface of the outer can.

Charging causes non-aqueous electrolyte secondary batteries to swell. When the wound electrode assembly is housed so that its winding axis direction is parallel to the bottom surface of the outer can, the swelling causes the electrode assembly to swell in the thickness direction of the outer can as well.

When a current interrupt device is provided in the upper portion of the wound electrode assembly, which is activated by the rising temperature inside the battery to ensure safety, the swelling of the electrode assembly causes the electrode assembly to come into contact with the current interrupt device, and the desired operation is sometimes not performed.

In order to prevent contact between the electrode assembly and the current interrupt device, the maximum width of the wound electrode assembly perpendicular to the winding axis direction during assembly has to remain within the distance from the bottom surface of the outer can to the current interrupt device. However, unlike during assembly of the battery, it is difficult to determine the maximum width of the wound electrode assembly perpendicular to the winding axis direction when the electrode assembly has swelled to the maximum extent.

The swelling of the electrode assembly is essentially due to the swelling of the negative electrode during charging, and the swelling of the negative electrode can be foreseen during battery assembly based on the composition of the negative electrode and its porosity. If the thickness of the negative electrode at an SOC of 100% is kept to within 130% of the thickness of the negative electrode during battery assembly, and if the maximum width of the wound electrode assembly perpendicular to the winding axis direction during production of the wound electrode assembly is kept to within 98% of the distance from the bottom surface of the outer can to the current interrupt device, the maximum width of the electrode assembly perpendicular to the winding axis direction when swollen to the maximum extent can be kept within the distance from the bottom surface of the outer can to the current interrupt device.

When the maximum width of the wound electrode assembly perpendicular to the winding axis direction during assembly is too small, the battery capacity declines. Therefore, the maximum width of the wound electrode assembly perpendicular to the winding axis direction during assembly has to be equal to or greater than 90% of the distance from the bottom surface of the outer can to the electrode interrupt device.

Here, the battery capacity is the discharge capacity (initial capacity) when the battery has been charged to a battery voltage of 4.1 V using 1 It of constant current, charged for 1.5 hours at a constant voltage of 4.1 V, and then discharged after charging to a battery voltage of 2.5 V at a constant current of 1 It. The charging and discharging was performed entirely at 25° C. Also, the value for 1 It is the current value at which the battery capacity is discharged for one hour.

Also, a state of charge of 100% means the battery has been charged to a voltage of 4.1 V at a constant current of 1 It, and then charged for 1.5 hours at a constant voltage of 4.1 V.

In this configuration, the non-aqueous electrolyte also contains lithium bis(oxalato)borate (LiB(C₂O₄)₂).

The addition of lithium bis(oxalato)borate to the non-aqueous electrolyte has the preferred action of improving the cycle characteristics.

When the non-aqueous electrolyte contains too little lithium bis(oxalato)borate, the effect is insufficient. When too much lithium bis(oxalato)borate is added, the upper limit on effectiveness is exceeded and the additional amount is not cost effective. Therefore, the amount of lithium bis(oxalato)borate added is preferably from 0.06 to 0.18 mol/L.

In this configuration, the non-aqueous electrolyte can also contain lithium difluorophosphate.

The addition of lithium difluorophosphate (LiPO₂F₂) to the non-aqueous electrolyte has the preferred action of improving the low temperature output characteristics.

When the non-aqueous electrolyte contains too little lithium difluorophosphate, the effect is insufficient. When too much lithium difluorophosphate is added, the upper limit on effectiveness is exceeded and the additional amount is not cost effective. Therefore, the amount of lithium difluorophosphate added is preferably from 0.01 to 0.10 mol/L.

The range for the amount of lithium bis(oxalato)borate and lithium difluorophosphate in the non-aqueous electrolyte is determined based on the non-aqueous electrolyte in the non-aqueous electrolyte secondary battery after assembly and before the first charge. The range is determined in this manner because the amount gradually decreases as the non-aqueous electrolyte battery containing lithium bis(oxalato)borate and lithium difluorophosphate is charged.

### Effect of the Invention

The present invention is able to provide with high productivity a non-aqueous electrolyte secondary battery having a high capacity.

### BRIEF DESCRIPTION OF THE DRAWINGS

FIG. 1 is a perspective view of a non-aqueous electrolyte secondary battery according to the present invention.

FIG. 2 are cross-sectional views of a non-aqueous electrolyte secondary battery according to the present invention in which FIG. 2 (a) is a vertical cross-sectional view perpendicular to the thickness direction of the battery, and FIG. 2 (b) is a vertical cross-sectional view parallel to the thickness direction of the battery.

FIG. 3a-3b are plan views showing the positive and negative electrodes used in a non-aqueous electrolyte secondary battery according to an embodiment of the present invention.

FIG. 4 is a partially enlarged perspective view of the electrode assembly used in a non-aqueous electrolyte secondary battery according to an embodiment the present invention.

### DETAILED DESCRIPTION

### Embodiment 1

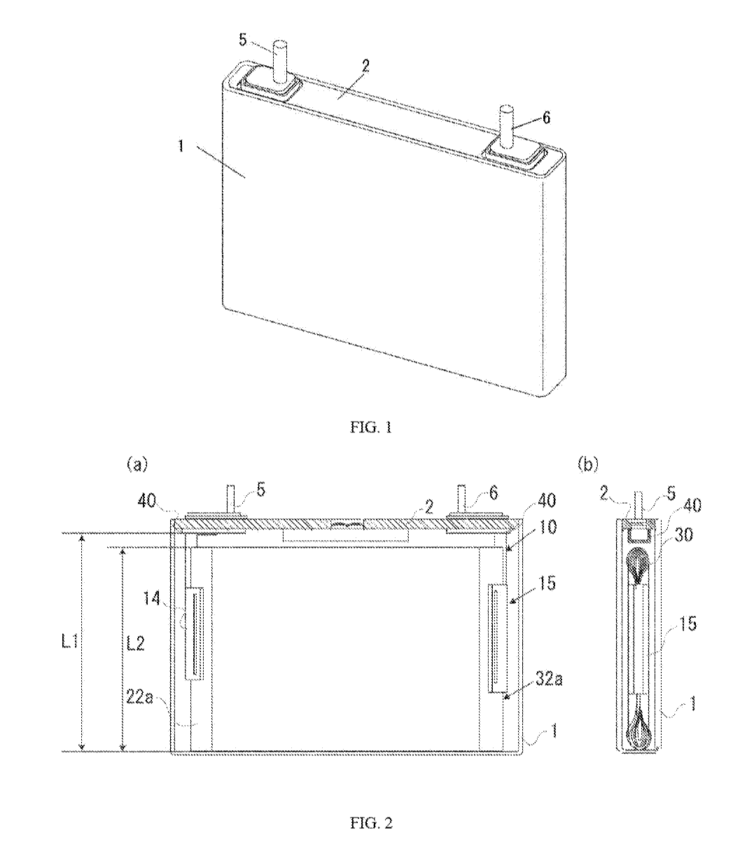

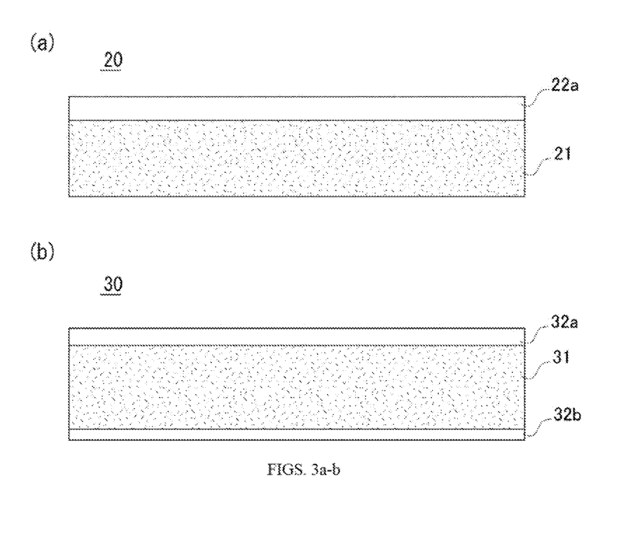

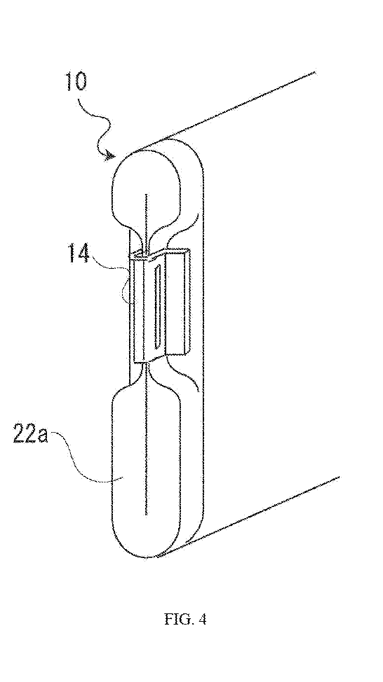

The following is an explanation with reference to the drawings of the rectangular battery of the present invention as applied to a lithium ion secondary battery. FIG. 1 is a perspective view of a non-aqueous electrolyte secondary battery according to the present invention, FIG. 2 are cross-sectional views of a non-aqueous electrolyte secondary battery according to the present invention in which FIG. 2 (a) is a vertical cross-sectional view perpendicular to the thickness direction of the battery and FIG. 2 (b) is a vertical cross-sectional view parallel to the thickness direction of the battery, and FIG. 3 is a plan view showing the positive and negative electrodes used in a non-aqueous electrolyte secondary battery according to an embodiment of the present invention.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3, the positive electrode 20 in the electrode assembly has a positive electrode core exposing portion 22a exposed on at least one end in the longitudinal direction of the band-shaped positive electrode core, and a positive electrode active material layer 21 formed on the positive electrode core. The negative electrode 30 has a first negative core exposing portion 32a and a second negative core exposing portion 32b exposed on both ends of the band-shaped negative electrode core in the longitudinal direction, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

As shown in FIG. 2 (a) and (b), the electrode assembly 10 is inserted along with the non-aqueous electrolyte into the outer can 1 so that the winding axis direction of the electrode assembly is parallel to the bottom surface of the can and the sealing plate. The positive electrode collector 14 and the negative electrode collector 15 are connected electrically to the outer terminals 5, 6 protruding from the sealing plate 2 while being insulated from the sealing plate 2 in order to extract current. Current interrupt devices 40, 40, which are activated by a rising temperature inside the battery, are provided between the positive electrode collector 14, the negative electrode collector 15, and the outer terminals 5, 6.

In this configuration, the thickness of the negative electrode 30 at a state of charge of 100% is within 130% of the thickness during battery assembly (when it does not contain lithium ions).

Also, as shown in FIG. 2 (a), the maximum width L2 of the wound electrode assembly 10 perpendicular to the winding axis direction during assembly is from 90 to 98% of the distance L1 from the bottom surface of the outer can 1 to the current interrupt device 40.

In a wound electrode assembly, the opposing area of the positive and negative electrodes is advantageously large, and the assembly is easier to manufacture. In a high-capacity electrode having a battery capacity equal to or greater than 4 Ah, the collector structure can be simplified when the wound electrode assembly is housed so that its winding axis direction is parallel to the bottom surface of the outer can.

However, charging causes non-aqueous electrolyte secondary batteries to swell. When the wound electrode assembly 10 is housed so that its winding axis direction is parallel to the bottom surface of the outer can 1, the swelling causes the electrode assembly 10 to swell in the thickness direction of the outer can 1 as well. When a current interrupt device 40 is provided in the upper portion of the wound electrode assembly 10, which is activated by the rising temperature inside the battery to ensure safety, the swelling of the electrode assembly 10 causes the electrode assembly 10 to come into contact with the current interrupt device 40, contact with the electrode assembly 10 maintains the electrical connection, and the desired operation is sometimes not performed.

If the thickness of the negative electrode at a state of charge of 100% is kept to within 130% of the thickness of the negative electrode during battery assembly, and if the maximum width of the wound electrode assembly perpendicular to the winding axis direction during production of the wound electrode assembly is kept to within 98% of the distance from the bottom surface of the outer can to the current interrupt device, the maximum width of the electrode assembly perpendicular to the winding axis direction when swollen to the maximum extent can be kept within the distance from the bottom surface of the outer can to the current interrupt device, and contact between the electrode assembly 10 and the current interrupt device 40 can be prevented.

When the maximum width of the wound electrode assembly perpendicular to the winding axis direction during assembly is too small, the battery capacity declines. Therefore, the maximum width of the wound electrode assembly perpendicular to the winding axis direction during assembly has to be equal to or greater than 90% of the distance from the bottom surface of the outer can to the electrode interrupt device.

The swelling of the negative electrode can be foreseen during negative electrode production by controlling the composition of the negative electrode and its porosity.

The (pressure-sensitive) current interrupt device, which is activated by an increase in the internal temperature of the battery, can have any configuration common in the art. One example has a diaphragm which is connected electrically to outside terminals and which has a central portion that becomes deformed and rises towards the outside of the battery when the internal battery pressure rises, and cut-off foil which is applied to the inside surface of the central portion of the diaphragm and which ruptures when the diaphragm is deformed and rises, cutting off the current to the diaphragm. The pressure-sensitive current interrupt device 40 is preferably arranged between the sealing plate 2 and the collectors 14, 15.

Because a substantial amount of current flows when a high-capacity battery with a battery capacity of 4 Ah or more malfunctions, the present invention is preferably applied to such a battery.

The following is a more detailed explanation of the present invention using examples. The present invention is not limited to these examples. The materials used, the mixing ratios, etc. can be changed when appropriate.

### Example 1

### Preparation of the Positive Electrode

The positive electrode active material slurry is prepared by mixing together a lithium-containing nickel-cobalt-manganese composite oxide (LiNi_{0.35}Co_{0.35}Mn_{0.3}O₂) serving as the positive electrode active material, a carbon-based charging agent such as acetylene black or graphite, and a binder such as polyvinylidene fluoride (PVDF) at a mass ratio of 88:9:3, and then dissolving and mixing the mixture in N-methyl-2-pyrrolidone serving as the organic solvent.

The positive electrode active material slurry is applied to a uniform thickness on both sides of band-shaped aluminum foil serving as the positive electrode core (thickness: 15 μm) using a die coater or doctoring blade. However, the slurry is not applied on the ends in the longitudinal direction of the positive electrode core (the end in the same direction on both sides) to expose the core and form the positive electrode core exposing portion 22a.

The electrode is passed through a dryer to remove the organic solvent and create a dry electrode. The dry electrode is then rolled using a roll press. Afterwards, it is cut to a predetermined size to complete the positive electrode 20.

### Preparation of Negative Electrode

The negative electrode active material slurry is prepared by mixing together graphite serving as the negative electrode active material, styrene butadiene rubber serving as the binder, and carboxymethyl cellulose serving as the thickener at a mass ratio of 98:1:1, and then adding the appropriate amount of water.

The negative electrode active material slurry is applied to a uniform thickness on both sides of band-shaped copper foil serving as the negative electrode core (thickness: 10 μm) using a die coater or doctoring blade. However, the slurry is not applied on the ends in the longitudinal direction of the negative electrode core to expose the core and form the negative electrode core exposing portions 32a, 32b.

The electrode is passed through a dryer to remove the water and create a dry electrode. The dry electrode is then rolled using a roll press. Afterwards, it is cut to a predetermined size to complete the negative electrode 30.

### Preparation of Electrode Assembly

The positive electrode, the negative electrode and a polyethylene microporous membrane separator were laid on top of each other so that the positive electrode core exposing portion 22a and the negative electrode core exposing portion 32a protruded from the three layers in opposite directions relative to the winding axis direction, and so that the separator was interposed between the different active material layers. The layers were then wound together using a winding machine, insulated tape was applied to prevent unwinding, and the resulting electrode assembly was flattened using a press.

### Connection of the Collectors to the Sealing Plate

One each of both a clip-shaped positive electrode collector 14 and a negative electrode collector 15 were prepared as shown in FIG. 4. A sealing plate 2 with a gas escape hole and a current interrupt device 40 was also prepared.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. A lead (not shown), which was connected to the positive electrode collector 14, was positioned on top of the insulating component on the inside surface of the sealing plate 2 so that the through-hole in the sealing plate 2 was aligned with the through-hole (not shown) in the collector. Afterwards, the inserted portion of a negative electrode terminal 5 having a flange portion (not shown) and an inserted portion (not shown) was inserted from outside the battery into the through-hole in the sealing plate 2 and the through-hole of the collector. The diameter of the lower end of the inserted portion (inside the battery) is then widened, and the positive electrode terminal 5 was caulked to the lead and the sealing plate 2.

On the negative electrode side, the negative electrode terminal 6 was caulked to the lead (not shown) and the sealing plate 2 in the same way. In this operation, the various components were integrated. Also, the positive and negative electrode terminals 5, 6 protruded from the sealing plate 2 while also being insulated from the sealing plate 2.

### Mounting of the Collectors

The positive electrode collector 14 is mounted so as to interpose the overlapping regions of the flat electrode assembly and the core exposing portion 22a of the positive electrode 20. Next, a pair of welding electrodes is pressed against both ends of the positive electrode collector 14, current flows through the pair of welding electrodes, and the positive electrode collector 14 is resistance-welded to the positive electrode core exposing portion 22a. In these operations, the positive electrode collector 14 is fixed to the positive electrode core exposing portion 22a.

Similarly, on the negative electrode 30 side, the negative electrode collector 15 is resistance-welded to the negative electrode core exposing portion 32a. Afterwards, the lead is resistance-welded to the positive and negative electrode collectors 14, 15. Both are fixed so that the winding axis direction of the wound electrode assembly is parallel to the plane direction of the sealing plate.

### Preparation of Non-Aqueous Electrolyte

Ethylene carbonate (EC) and ethyl methyl carbonate (EMC) are mixed together at a volume ratio of 3:7 (converted to 1 atm (101,325 Pa) at 25° C.), and a LiPF₆ electrolyte salt is dissolved in the resulting non-aqueous solvent at a ratio of 1.0 M (mol/L) to complete the base electrolyte. To the resulting base electrolyte are added 0.3 mass % vinylene carbonate, 0.1 mol/L lithium bis(oxalato)borate (LiB(C₂O₄)₂), and 0.05 mol/L lithium difluorophosphate (LiPO₂F₂), which completes the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the sealing plate 2, and the non-aqueous electrolyte hole was sealed. This completes the non-aqueous electrolyte secondary battery in the first example which has a battery capacity of 5 Ah.

When the negative electrode prepared in this manner was charged to a voltage of 4.1 V at a constant current of 1 It (5 A) and then charged for 2.5 hours at a constant voltage of 4.1 V, the thickness (SOC 100% thickness) was 112% of the thickness during assembly. Also, the maximum width of the wound electrode assembly perpendicular to winding axis during assembly was 97.4% of the distance from the bottom surface of the outer can to the current interrupt device.

### Example 2

The non-aqueous electrolyte secondary battery of the second example was prepared in the same manner as the first example except that the mixing ratio of the negative electrode active material slurry and the rolling pressure were changed so that the SOC 100% thickness of the negative electrode was 118% of the thickness at the time of assembly, the maximum width of the wound electrode assembly perpendicular to winding axis during assembly was 97.8% of the distance from the bottom surface of the outer can to the current interrupt device, and the battery capacity was 25 Ah.

### Comparative Example 1

The non-aqueous electrolyte secondary battery of the first comparative example was prepared in the same manner as the second example except that the mixing ratio of the negative electrode active material slurry and the rolling pressure were changed so that the SOC 100% thickness of the negative electrode was 118% of the thickness at the time of assembly, and the maximum width of the wound electrode assembly perpendicular to winding axis during assembly was 98.5% of the distance from the bottom surface of the outer can to the current interrupt device.

### Measurement of Battery Swelling

The non-aqueous electrolyte secondary batteries in the first and second examples were charged to a voltage of 4.1 V at a constant current of 1 It (5 A in the first example and 25 A in the second example), and then charged for 2.5 hours at a constant voltage of 4.1 V. Afterwards, the batteries were disassembled, and the maximum width thickness (SOC 100% thickness) of the wound electrode assembly perpendicular to the winding axis direction was measured. As a result, the value of (SOC 100% thickness/distance from bottom surface of outer can to current interrupt device×100) was 98.0 in the case of the first example and 99.5 in the case of the second example. When estimated from the SOC 100% thickness of the positive electrode and negative electrode in the non-aqueous electrolyte secondary battery of the first comparative example, the result was 100.2.

### Overcharge Test

In the case of the batteries in the first and second example, a (SOC 100% thickness/distance from bottom surface of outer can to current interrupt device×100) value of less than 100 indicates the possibility of smoke and fire when overcharged. These results indicate that the first and second examples did not smoke and catch fire.

Charging causes non-aqueous electrolyte secondary batteries to swell. When the wound electrode assembly is housed so that its winding axis direction is parallel to the bottom surface of the outer can, the swelling causes the electrode assembly to swell in the height direction of the outer can as well. Swelling of the electrode assembly causes the electrode assembly to come into contact with the current interrupt device, and the desired operation is sometimes not performed.

Here, as in the case of the first and second examples, if the thickness of the negative electrode at an SOC of 100% is kept to within 130% of the thickness of the negative electrode during battery assembly, and if the maximum width of the wound electrode assembly perpendicular to the winding axis direction during production of the wound electrode assembly is kept to within 98% of the distance from the bottom surface of the outer can to the current interrupt device, the maximum width of the electrode assembly perpendicular to the winding axis direction when swollen to the maximum extent can be kept within the distance from the bottom surface of the outer can to the current interrupt device (SOC 100% thickness/distance from bottom surface of outer can to current interrupt device×100<100). This can prevent swelling of the electrode assembly from causing the electrode assembly to make contact with the current interrupt device.

Because contact between the electrode assembly and current interrupt device due to swelling of the electrode assembly can be foreseen in the case of the first and second examples, the current interrupt device operates normally during the overcharge test and the battery can be prevented from smoking and catching fire.

### Additional Details

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

The negative electrode active material can be a carbon material such as natural graphite, carbon black, coke, glassy carbon, carbon fibers, or baked products of these. These carbon materials can be used alone or in mixtures of two or more.

Also, a protective layer can be provided on at least one side of the positive electrode active material layer and the negative electrode active material layer. The protective layer preferably contains insulating inorganic particles and a binder. The inorganic particles can be metal oxide particles such as zirconia, alumina and titania. The binder can be an acrylonitrile-based binder or a fluorine-based binder.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

One or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)F₂, LiP(C₂O4)₃, LiP(C₂O₄)₂F₂, and LiP(C₂O₄)F₄. Lithium bis(oxalato)borate LiB(C₂O₄)₂ and lithium difluorophosphate (LiPO₂F₂) can be added to the base electrolyte salts. The total concentration of electrolyte salts in the non-aqueous electrolyte is preferably from 0.5 to 2.0 M (mol/L).

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide with high productivity a non-aqueous electrolyte secondary battery having a high capacity. Thus, industrial applicability is great.

### KEY TO THE DRAWINGS

1: Outer Can
2: Sealing Plate
5, 6: Electrode Terminals
10: Electrode Assembly
14: Positive Electrode Collector
15: Negative Electrode Collector
20: Positive Electrode
21: Positive Electrode Active Material Layer
22a: Positive Electrode Core Exposing Portion
30: Negative Electrode
31: Negative Electrode Active Material Layer
32a, 32b: Negative Electrode Core Exposing Portions
40: Current Interrupt Device

What is claimed is:

1. A non-aqueous electrolyte secondary battery including a wound electrode assembly of a positive electrode, negative electrode and separator housed in an outer can having both a bottom and an opening, the opening being sealed by a sealing plate, the non-aqueous electrolyte secondary battery characterized in that the battery further comprises a current interrupt device activated by rising pressure inside the battery, the bottom surface of the outer can is parallel to the direction of the winding axis of the wound electrode assembly, the thickness of the negative electrode at a state of charge of 100% is equal to or less than 130% of the thickness of the negative electrode at the time of battery assembly, the maximum width of the wound electrode assembly perpendicular to the winding axis direction during assembly is from 90 to 98% of the distance from the bottom surface of the outer can to the current interrupt device, and the battery capacity of the non-aqueous electrolyte secondary battery is equal to or greater than 4 Ah.

2. The non-aqueous electrolyte secondary battery according to claim 1, wherein the non-aqueous electrolyte also contains lithium bis(oxalato)borate.

3. The non-aqueous electrolyte secondary battery according to claim 1, wherein the non-aqueous electrolyte also contains lithium difluorophosphate.
